(19) United States
(12) Patent Application Publication
(10) Pub. No.: US 2026/0238903 A1
(43) Pub. Date: Aug. 13, 2026

(54) DYNAMIC BANDWIDTH ALLOCATION METHOD THAT COMBINES FLOW MONITORING AND STATUS REPORTING AND RELATED OPTICAL LINE TERMINAL

(71) Applicant: Airoha Technology (Suzhou) Limited, Suzhou City (CN)

(72) Inventors: JUN PAN, Nanjing City (CN); JINHUA ZHANG, Suzhou City (CN)

(73) Assignee: Airoha Technology (Suzhou) Limited, Suzhou City (CN)

(21) Appl. No.: 19/216,738

(22) Filed: May 23, 2025

(30) Foreign Application Priority Data
Feb. 11, 2025 (CN) 202510150391.3

(51) Int. Cl. H04Q 11/00; H04B 10/27; H04J 3/16

(52) U.S. Cl. CPC H04Q 11/0062; H04B 10/27; H04J 3/1694; H04Q 2011/0075; H04Q 2011/0086; H04Q 2011/0088

(57) ABSTRACT

A dynamic bandwidth allocation method includes: within an available upstream bandwidth of an optical line terminal (OLT), receiving an upstream frame that is sent via a plurality of transmission containers with a plurality of current bandwidths allocated thereto in a time division multiple access (TDMA) manner; and referring to a plurality of current dynamic bandwidth report unit (dbru) values corresponding to the plurality of transmission containers and a plurality of current valid-data ratios corresponding to the plurality of transmission containers to determine a plurality of next bandwidths that are allocated to the plurality of transmission containers.

### BACKGROUND OF THE INVENTION

### 1. Field of the Invention

The present invention relates to a dynamic bandwidth allocation (DBA) technique, and more particularly, to a DBA method that combines flow monitoring and status reporting and a related optical line terminal (OLT).

### 2. Description of the Prior Art

Gigabit Passive Optical Network (GPON) is the latest generation of broadband passive optical network standards that are based on the ITU-TG. 984.x standards. It has many advantages such as high bandwidth, high efficiency, large coverage, and low operating cost. The downstream direction (e.g., from an optical line terminal (OLT) to a plurality of optical network units (ONUs)) uses broadcasting, while the upstream direction (e.g., from a plurality of ONUs to an OLT) uses time division multiple access (TDMA) to allocate the bandwidth. Each ONU shares the same optical distribution network (ODN). To ensure that data does not overlap or conflict, there may be at most one transmission container (tcont) allowed to access the shared ODN at any time in the upstream direction. Hence, the OLT uses two fields, including a start_time field and a stop_time field, to indicate the start time and the end time of data transmission for each transmission container, wherein the bandwidth allocated to each transmission container is in bytes. In addition, each ONU may have one or more transmission containers. Therefore, the OLT needs an innovative DBA scheme which can meet the real-time requirement and avoid the problem of inaccurate bandwidth allocation caused by erroneous information reported by the ONU (e.g., a value reported by a dynamic bandwidth report unit (dbru)).

### SUMMARY OF THE INVENTION

One of the objectives of the claimed invention is to provide a dynamic bandwidth allocation method that combines flow monitoring and status reporting and a related optical line terminal.

According to a first aspect of the present invention, an exemplary dynamic bandwidth allocation (DBA) method is disclosed. The exemplary DBA method includes: within an available upstream bandwidth of an optical line terminal (OLT), receiving an upstream frame that is sent via a plurality of transmission containers with a plurality of current bandwidths allocated thereto in a time division multiple access (TDMA) manner; and referring to a plurality of current dynamic bandwidth report unit (dbru) values corresponding to the plurality of transmission containers, respectively, and a plurality of current valid-data ratios corresponding to the plurality of transmission containers, respectively, to determine a plurality of next bandwidths that are allocated to the plurality of transmission containers, respectively.

According to a second aspect of the present invention, an exemplary optical line terminal (OLT) is disclosed. The exemplary OLT includes a receiver circuit and a processor. Within an available upstream bandwidth of the OLT, the receiver circuit is configured to receive an upstream frame that is sent via a plurality of transmission containers with a plurality of current bandwidths allocated thereto in a time division multiple access (TDMA) manner. The processor is configured to perform dynamic bandwidth allocation (DBA). The processor is configured to refer to a plurality of current dynamic bandwidth report unit (dbru) values corresponding to the plurality of transmission containers, respectively, and a plurality of current valid-data ratios corresponding to the plurality of transmission containers, respectively, to determine a plurality of next bandwidths that are allocated to the plurality of transmission containers, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an optical line terminal according to an embodiment of the present invention.

FIG. 2 is a diagram illustrating information of a valid-data ratio provided by traffic monitoring.

FIG. 3 is a diagram illustrating a dynamic bandwidth report unit value provided by status reporting.

FIG. 4 is a flowchart illustrating a dynamic bandwidth allocation method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

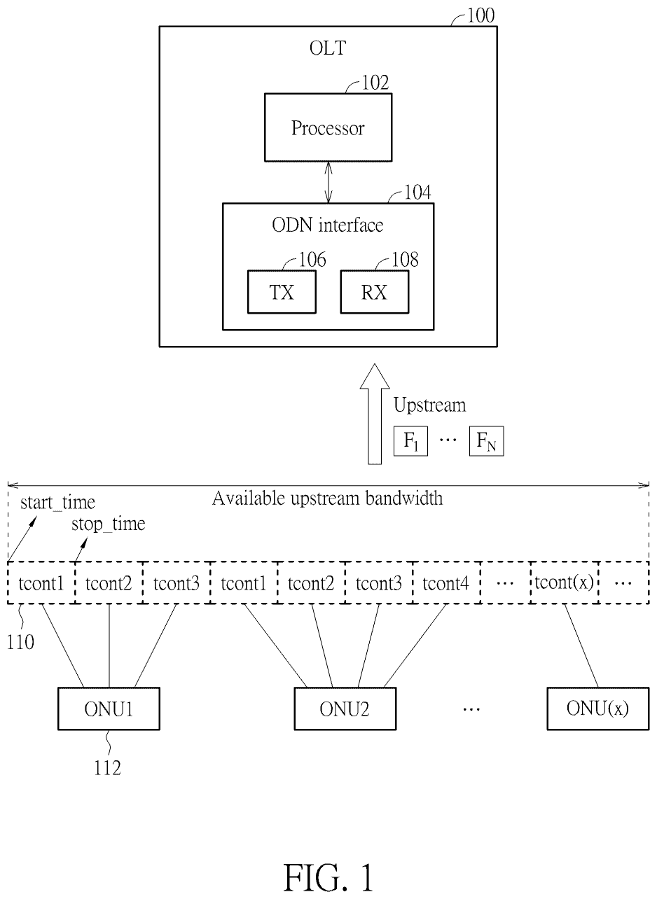

FIG. 1 is a diagram illustrating an optical line terminal (OLT) according to an embodiment of the present invention. The OLT 100 supports the dynamic bandwidth allocation (DBA) method proposed by the present invention, and includes a processor 102 and an optical distribution network (ODN) interface 104, wherein the ODN interface 104 includes a transmitter circuit (labeled by “TX”) 106 and a receiver circuit (labeled by “RX”) 108. Please note that only the components pertinent to the present invention are illustrated in FIG. 1. In practice, the OLT 100 may include other components to achiev designed functions. For example, the OLT 100 may include a media access control (MAC) circuit for extracting frame contents of an upstream frame received by the ODN interface 104 and providing the extracted frame contents to the processor 102. The transmitter circuit 106 is configured to process the transmission of a plurality of downstream frames, wherein the frame duration of each downstream frame is 125 us. In this embodiment, the processor 102 is configured to perform DBA. Therefore, the OLT 100 can inform a plurality of optical network units (ONUs) (labeled by “ONU1”, “ONU2”, . . . , “ONU (x)”) 112 of the bandwidth allocation results of a plurality of transmission containers (tcont) 110 through a downstream frame. The receiver circuit 108 is configured to receive a plurality of upstream frames F1-FN transmitted by the plurality of ONUs 112, wherein the frame duration of each upstream frame is 125 us. In this embodiment, within an available upstream bandwidth of the OLT 100, the receiver circuit 108 is configured to receive an upstream frame (e.g., any of upstream frames F1-FN) that is sent via a plurality of transmission containers 110 with a plurality of current bandwidths pre_alloc_band (which are determined by the processor 102 performing a previous DBA operation) allocated thereto in a TDMA manner, wherein each transmission container indicates the start time of data transmission and the end time of data transmission through two fields, including start_time and stop_time set by the OLT 100. Specifically, the settings of start_time and stop_time are set based on the bandwidth allocated to the transmission container. As mentioned above, the processor 102 is configured to perform DBA. In this embodiment, the processor 102 is configured to determine a plurality of next bandwidths next_alloc_band to be allocated to the plurality of transmission containers 110, respectively, by referring to a plurality of current dbru values and a plurality of current valid-data ratios corresponding to the plurality of transmission containers 110, respectively. Please note that “previous”, “current” and “next” are used to define a sequential order in the time domain. For example, the previous bandwidth of the transmission container 110 refers to the bandwidth allocated by a DBA operation performed by the processor 102 at the time point Tₙ₋₂ and applied to transmission of an upstream frame at the time point Tₙ₋₁, the current bandwidth of the transmission container 110 refers to the bandwidth allocated by a DBA operation performed by the processor 102 at the time point Tₙ₋₁ and applied to transmission of an upstream frame at the time point Tₙ, and the next bandwidth of the transmission container 110 refers to the bandwidth allocated by a DBA operation performed by the processor 102 at the time point Tₙ and applied to transmission of the upstream frame at the time point Tₙ₊₁.

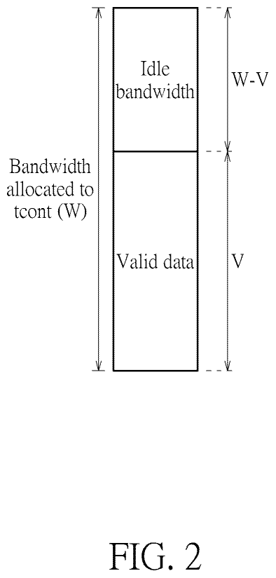

In this embodiment, the DBA performed by the processor 102 adopts the proposed DBA method that combines traffic monitoring and status reporting. FIG. 2 is a diagram illustrating information of a valid-data ratio provided by traffic monitoring. In a traffic monitoring mode, the OLT 100 (particularly, processor 102 of OLT 100) monitors the usage of the current bandwidth allocated to each transmission container in real time. As shown in FIG. 2, the current bandwidth allocated to the transmission container (tcont) is W bytes. Assuming that the amount of valid data is V bytes, the idle bandwidth in the transmission container is (W-V) bytes. At this moment, the valid-data ratio is

$$\frac{V}{W} .$$

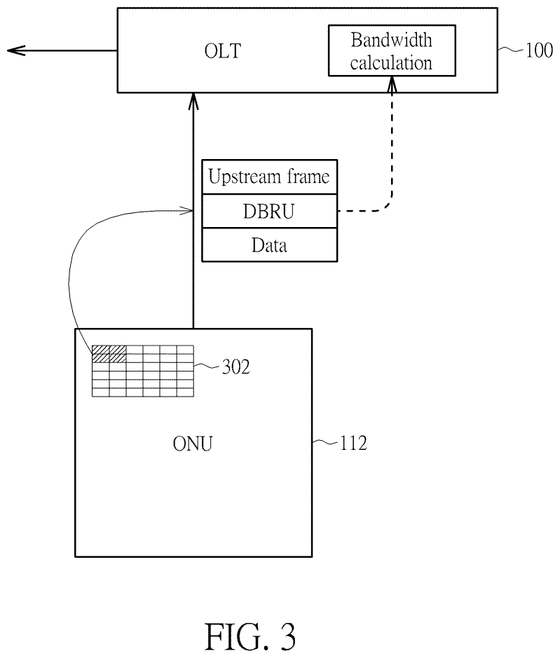

FIG. 3 is a diagram illustrating a dbru value provided by status reporting. In a status reporting mode, the ONU 112 uses a micro time slot to report a status of the to-be-transmitted data temporarily stored in its local buffer 302 to the OLT 100 in the format of a dynamic bandwidth reporting unit (labeled as “DBRU”). For example, the buffer 302 can be allocated within a dynamic random access memory (DRAM), and can be divided into a plurality of storage blocks according to a fixed block size. Therefore, the number of storage blocks that store the to-be-transmitted data in the buffer 302 can be converted into a dbru value (i.e., a value reported by a dbru) and then sent to the OLT 100 through the upstream frame. In other words, the OLT 100 (particularly, processor 102 of OLT 100) can know the upstream bandwidth demand of the ONU 112 in real time through the reported dbru value. Although the status reporting method can react in real time, the ONU 112 may report an erroneous dbru value. Therefore, in addition to the information provided by the status reporting, the DBA method disclosed by the present invention also refers to the information provided by the flow monitoring (e.g., the valid-data ratio) to determine the bandwidth allocated to each transmission container.

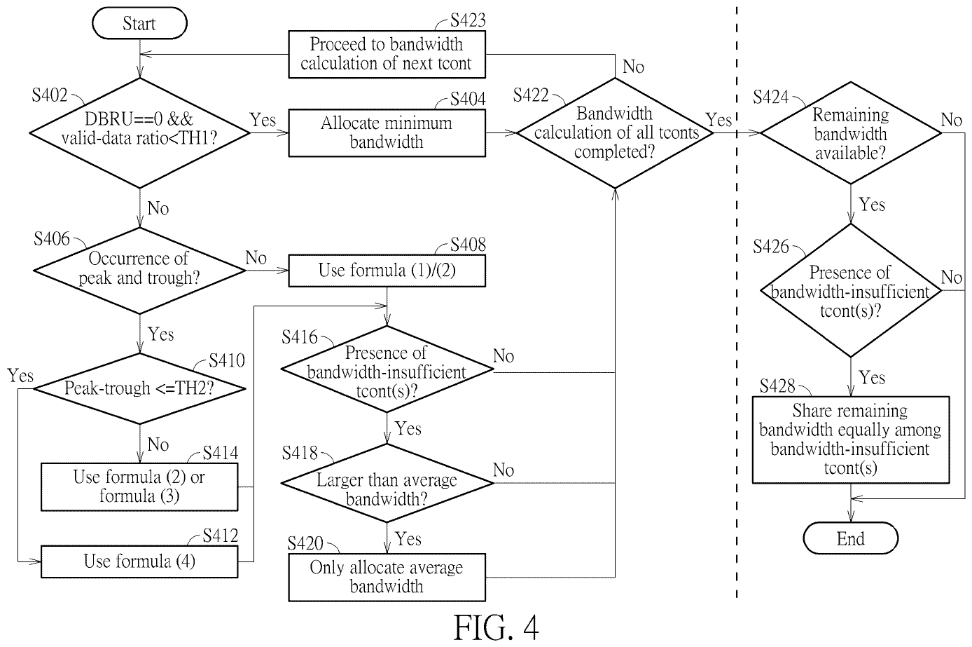

FIG. 4 is a flowchart illustrating a DBA method according to an embodiment of the present invention. The DBA method may be performed by the processor 102 shown in FIG. 1. Furthermore, if the result is substantially the same, the steps are not required to be executed in the exact order shown in FIG. 4. When performing DBA, the processor 102 performs bandwidth calculation for each transmission container (tcont) sequentially. In step S402, the processor 102 determines whether the current dbru value of the transmission container is equal to zero, and determines whether the current valid-data ratio of the transmission container is lower than a threshold TH1 (e.g., TH1=⅓). When the current dbru value of the transmission container is equal to zero (dbru==0) and the current valid-data ratio of the transmission container is lower than the threshold TH1 (e.g., TH1=⅓), this indicates that the transmission container is no longer in a flowing state. Therefore, the processor 102 releases its bandwidth and only retains the minimum bandwidth. In other words, the processor 102 allocates the minimum bandwidth to the transmission container as the next bandwidth of the transmission container (step S404). Please note that the value (bytes) of the minimum bandwidth can be determined according to actual design requirements.

When the current dbru value of the transmission container is not equal to zero and/or the current valid-data ratio of the transmission container is not lower than the threshold TH1 (e.g., TH1=⅓), this indicates that the transmission container is still in a flowing state, and therefore the DBA process proceeds to step S406. In step S406, the processor 102 determines whether a peak and a trough occur in the bandwidth allocation process of the transmission container, wherein the peak refers to a turning point (i.e., bandwidth decrease) after the transmission container is continuously allocated by a gradually increasing bandwidth, and a trough refers to a turning point (i.e., bandwidth increase) after the transmission container is continuously allocated by a gradually decreasing bandwidth. Before the peak and the trough both occur in the bandwidth allocation process of the transmission container, the processor 102 calculates the next bandwidth of the transmission container according to the following formula (1) and formula (2) (step S408).

$$diff = new\_dbru \_value - old\_dbru \_value \qquad ( 1 )$$

$$next\_alloc \_band = pre\_alloc \_band + DBRU\_BLOCK \_SIZE * diff \qquad ( 2 )$$

In formula (1), new_dbru_value is the current dbru value (i.e., the dbru value reported in the upstream frame transmitted by the transmission container with the bandwidth of pre_alloc_band), old_dbru_value is the previous dbru value (i.e., old_dbru_value and new_dbru_value are dbru values sequentially reported by the same ONU), and diff is the difference value between the current dbru value and the previous dbru value.

In formula (2), pre_alloc_band is the current bandwidth allocated to the transmission container (i.e., the value obtained by the previous bandwidth calculation), next_alloc_band is the bandwidth calculation result obtained by the present bandwidth calculation that is used as the next bandwidth allocated to the transmission container, and DBRU_BLOCK_SIZE is an adjustable parameter (e.g., the default value is 48). In formula (2), DBRU_BLOCK_SIZE*diff can be regarded as an adjustment amount applied to pre_alloc_band.

As can be seen from formula (1) and formula (2), when the allocated bandwidth exceeds the actual demand, new_dbru_value will be smaller than old_dbru_value. At this moment, since the difference value diff is smaller than 0, next_alloc_band is smaller than pre_alloc_band, which can be used to detect the formation of a peak. When the allocated bandwidth is lower than the actual demand, new_dbru_value will be larger than old_dbru_value. At this moment, since the difference value diff is larger than 0, next_alloc_band is larger than pre_alloc_band, which can be used to detect the formation of a trough.

After the peak and the trough both occur in the bandwidth allocation process of the transmission container, the DBA method proposed by the present invention will try to allocate the subsequent bandwidth between these two values (i.e., peak and trough). In addition, when the calculated bandwidth is close to the peak, the DBA method proposed by the present invention may slow down the increment rate of the bandwidth; and when the calculated bandwidth is close to the trough, the DBA method proposed by the present invention may slow down the decrement rate of the bandwidth. In addition, after the peak and the trough are formed, a new peak and a new trough will be formed subsequently. When the difference value between the peak and the trough is not larger than the threshold TH2 (e.g., TH2=1000), the DBA method proposed by the present invention enters a fine-tuning phase to further slow down the increment rate and the decrement rate of the bandwidth. The related operation details are described as follows.

In step S410, the processor 102 determines whether the difference value between the peak and the trough is not larger than the threshold TH2 (e.g., TH2=1000). When the difference value between the peak and the trough is larger than the threshold TH2 (e.g., TH2=1000), the processor 102 performs step S414. In step S414, when the bandwidth calculated by formula (2) is distant from the peak/trough, the processor 103 uses the bandwidth calculated by formula (2) to determine the next bandwidth of the transmission container. However, when the bandwidth calculated by formula (2) is close to the peak/trough, the processor 102 calculates the next bandwidth of the transmission container according to the following formula (3).

$$next\_alloc \_band = pre\_alloc \_band + ( DBRU\_BLOCK \_SIZE * diff ) / X ( X > 1 ) \qquad ( 3 )$$

The related operations that are performed when the bandwidth calculated by formula (2) is close to the peak/trough can be represented by the following pseudo code, where peak is the peak value, trough is the trough value, and M>N>Q (e.g., M=5, N=4, Q=3).

```
If (diff < 0)
  if (next_alloc_band < (peak+trough)*(Q/M))
    next_alloc_band=pre_alloc_band+(DBRU_BLOCK_SIZE*diff)/X
    (X>1)
if (diff > 0)
  if (next_alloc_band > (peak+trough)*(N/M))
    next_alloc_band = pre_alloc_band + (DBRU_BLOCK_SIZE*diff)/X
    (X>1)
```

If the bandwidth next_alloc_band calculated by formula (2) is distant from the trough (i.e., diff<0 and next_alloc_band>=(peak+trough)*(Q/M)), step S414 outputs the bandwidth next_alloc_band calculated by formula (2) as the bandwidth calculation result obtained by the present bandwidth calculation for acting as the next bandwidth allocated to the transmission container, wherein the adjustment amount applied to pre_alloc_band by formula (2) is DBRU_BLOCK_SIZE*diff. Similarly, if the bandwidth next_alloc_band calculated by formula (2) is distant from the peak (i.e., diff>0 and next_alloc_band<=(peak+trough)*(Q/M)), step S414 outputs the bandwidth next_alloc_band calculated by formula (2) as the bandwidth calculation result obtained by the present bandwidth calculation for acting as the next bandwidth allocated to the transmission container.

However, if the bandwidth next_alloc_band calculated by formula (2) is close to the trough (i.e., diff<0 and next_alloc_band<(peak+trough)*(Q/M)), step S414 outputs the bandwidth next_alloc_band calculated by formula (3) as the bandwidth calculation result obtained by the present bandwidth calculation for acting as the next bandwidth allocated to the transmission container, wherein the adjustment amount DBRU_BLOCK_SIZE*diff/X (X>1) applied to pre_alloc_band by formula (3) is smaller than the adjustment amount DBRU_BLOCK_SIZE*diff applied to pre_alloc_band by formula (2). Similarly, if the bandwidth next_alloc_band calculated by formula (2) is close to the peak (i.e., diff>0 and next_alloc_band>(peak+trough)*(Q/M)), step S414 outputs the bandwidth next_alloc_band calculated by formula (3) as the bandwidth calculation result obtained by the present bandwidth calculation for acting as the next bandwidth allocated to the transmission container, wherein the adjustment amount DBRU_BLOCK_SIZE*diff/X (X>1) applied to pre_alloc_band by formula (3) is smaller than the adjustment amount DBRU_BLOCK_SIZE*diff applied to pre_alloc_band by formula (2).

When step S410 determines that the difference value between the peak and the trough is not larger than the threshold TH2 (e.g., TH2=1000), the processor 102 performs step S412. In step S412, the processor 102 calculates the next bandwidth of the transmission container by using the following formula (4).

$$next\_alloc \_band = pre\_alloc \_band + ( DBRU\_BLOCK * diff ) / Y ( Y > X > 1 ) \qquad ( 4 )$$

During the fine-tuning phase (step S412), the adjustment amount DBRU_BLOCK_SIZE*diff is divided by a larger parameter Y (Y>X) to further reduce the bandwidth change rate, and a new peak or a new trough will be formed subsequently. Specifically, the adjustment amount DBRU_BLOCK_SIZE*diff/Y (Y>X>1) applied to pre_alloc_band by formula (4) smaller than is the adjustment amount DBRU_BLOCK_SIZE*diff/X applied to pre_alloc_band by formula (3), and is also smaller than the adjustment amount DBRU_BLOCK_SIZE*diff applied to pre_alloc_band by formula (2).

The above-mentioned DBA operation causes the bandwidth to change in a wave-like manner as new peaks and new troughs are continuously formed, and adopts the form of large jump and small fine-tuning. Therefore, before the peak/trough is formed, the bandwidth is greatly increased or decreased; and after a stable peak-trough range is established, the magnitude of the bandwidth change is gradually reduced. However, when the bandwidth calculation is in a special state, in order to ensure that the final allocated bandwidth is stabilized around a value, the processor 102 may further determine whether the difference value diff is smaller than the threshold TH3. When the difference value diff is smaller than the threshold TH3 (i.e., the difference value diff is very small), the processor 102 may directly use the difference value diff as the adjustment amount, as shown in the following formula (5).

$$next\_alloc \_band = pre\_alloc \_band + diff \qquad ( 5 )$$

For example, when the difference value diff is very small, formula (5) can be used to take the place of formula (3) and formula (4). However, the present invention is not limited thereto.

In addition, if the dbru value has no change (i.e., diff=0), the processor 102 may further check whether the current dbru value is smaller than a threshold TH4. When the difference value diff is equal to zero and the current dbru value is smaller than the threshold TH4, the processor 102 determines that the bandwidth needs to be reduced at this moment. Hence, the current bandwidth pre_alloc_band may be multiplied by a parameter (e.g., S/100, where S<100) to generate a product as the bandwidth calculation result obtained by the present bandwidth calculation for acting as the next bandwidth allocated to the transmission container, as shown in the following formula (6).

$$next\_alloc \_band = pre\_alloc \_band * ( S / 100 ) ( S < 100 ) \qquad ( 6 )$$

When the difference value diff is equal to zero and the current dbru value is not smaller than the threshold TH4, the processor 102 determines that the bandwidth needs to be increased at this moment. Hence, the current bandwidth pre_alloc_band may be multiplied by another parameter (e.g., T/100, where T>100) to generate a product as the bandwidth calculation result obtained by the present bandwidth calculation for acting as the next bandwidth allocated to the transmission container, as shown in the following formula (7).

$$next\_alloc \_band = pre\_alloc \_band * ( T / 100 ) ( T > 100 ) \qquad ( 7 )$$

In addition, if a bandwidth competition scenario involves multiple transmission containers, the processor 102 needs to check whether other transmission containers are in a bandwidth deficiency state before allocating the calculated bandwidth in each bandwidth allocation operation (step S416). For example, when the information provided by the traffic monitoring indicates that the valid-data ratio is 100% and the dbru value provided by the status reporting exceeds a threshold TH5, this transmission container can be regarded as a bandwidth-insufficient transmission container. When there is no transmission container with insufficient bandwidth, the next_alloc_band calculated by one of the formulas (2) to (7) can be used as the bandwidth calculation result obtained in the present bandwidth calculation for acting as the next bandwidth allocated to the transmission container. However, when there is at least one transmission container with insufficient bandwidth, the processor 102 further determines whether the next_alloc_band calculated by one of the formulas (2) to (7) is larger than a relative average bandwidth average_band of the transmission container. If next_alloc_band is larger than average_band, the processor 102 uses average_band to take the place of next_alloc_band calculated by one of the formulas (2) to (7) for acting as the next bandwidth allocated to the transmission container (steps S418 and S420), as shown in the following pseudo code.

if (next_alloc_band > average_band)
next_alloc_band = average_band

average_band is the relative average bandwidth of each transmission container, which can be obtained by the following formula (8).

$$average\_band ( i ) = ( max\_band ( i ) / {\sum }_{i = 0}^{n} max\_band ( i ) ) * total\_band \qquad ( 8 )$$

In formula (8), max_band(i) is the maximum bandwidth allocated to the i^{th} transmission container (e.g., a bandwidth value calculated in a previous DBA operation),

$${\sum }_{i = 0}^{n} max\_band ( i )$$

is the sum of maximum bandwidths of (n+1) transmission containers (e.g., a sum of bandwidth values calculated for (n+1) transmission containers in a previous DBA operation), and total_band is the total bandwidth that can be currently allocated by the OLT. In addition, each time a bandwidth is allocated, it is needed to be subtracted from the total bandwidth, and other transmission containers that have not yet allocated their bandwidth will compete for the remaining bandwidth. For example, each time a transmission container completes bandwidth calculation,

$${\sum }_{i = 0}^{n} max\_band ( i )$$

in formula (8) (i.e., the sum of maximum bandwidths of transmission containers that have not yet completed bandwidth calculation) will be updated accordingly to calculate the relative average bandwidth average_band of the next transmission container for use in step S418. However, this is for illustrative purposes only, and is not meant to be a limitation of the present invention.

In step S422, the processor 102 determines whether bandwidth calculation has been completed for all transmission containers. If there are still transmission containers that have not completed their bandwidth calculation, the DBA process proceeds to step S423 to continue bandwidth calculation for the next transmission container.

When the processor 102 determines that bandwidth calculation has been completed for all transmission containers, the DBA process performs the last ending operation for getting a chance to adjust the bandwidth allocation results for some transmission containers (particularly, transmission containers with insufficient bandwidth). In step S424, the processor 102 determines whether the available upstream bandwidth of the OLT 100 still has remaining bandwidth available for allocation after the bandwidth calculation of all transmission containers is completed. If the available upstream bandwidth of the OLT 100 still has remaining bandwidth available for allocation after calculation of bandwidth all transmission containers is completed, the processor 102 determines whether there is at least one transmission container with insufficient bandwidth (step S426). If there is at least one transmission container with insufficient bandwidth, the processor 102 makes the remaining bandwidth shared equally among the at least one transmission container in step S428, to further increase the bandwidth allocated to the transmission container with insufficient bandwidth.

In summary, the present invention proposes a DBA method that combines status reporting and traffic monitoring. The proposed DBA method may have the following advantages. It is mainly based on status reporting, so it can meet the real-time requirements. It takes into account the information of traffic monitoring, thereby reducing the impact of inaccurate bandwidth demands caused by reporting erroneous dbru values. It follows the characteristics of traffic jitter, reduces the magnitude of bandwidth jitter, and thus speeds up the convergence time of bandwidth allocation. It meets the bandwidth competition needs of multiple transmission containers, and refers to the ratio of actual needs for achieving fair bandwidth allocation through applying refund to over-allocated bandwidth and supplement to under-allocated bandwidth.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dynamic bandwidth allocation (DBA) method comprising:
within an available upstream bandwidth of an optical line terminal (OLT), receiving an upstream frame that is sent via a plurality of transmission containers with a plurality of current bandwidths allocated thereto in a time division multiple access (TDMA) manner; and
referring to a plurality of current dynamic bandwidth report unit (dbru) values corresponding to the plurality of transmission containers, respectively, and a plurality of current valid-data ratios corresponding to the plurality of transmission containers, respectively, to determine a plurality of next bandwidths that are allocated to the plurality of transmission containers, respectively.

2. The DBA method of claim 1, wherein referring to the plurality of current dbru values corresponding to the plurality of transmission containers, respectively, and the plurality of current valid-data ratios corresponding to the plurality of transmission containers, respectively, to determine the plurality of next bandwidths that are allocated to the plurality of transmission containers, respectively, comprises:
regarding each transmission container included in the plurality of transmission containers:
determining whether a current dbru value of the transmission container is equal to zero;
determining whether a current valid-data ratio of the transmission container is smaller than a threshold; and
in response to the current dbru value of the transmission container being equal to zero and the current valid-data ratio of the transmission container being smaller than the threshold, allocating a minimum bandwidth to the transmission container as a next bandwidth of the transmission container.

3. The DBA method of claim 1, wherein referring to the plurality of current dbru values corresponding to the plurality of transmission containers, respectively, and the plurality of current valid-data ratios corresponding to the plurality of transmission containers, respectively, to determine the plurality of next bandwidths that are allocated to the plurality of transmission containers, respectively, comprises:
regarding each transmission container included in the plurality of transmission containers:
calculating a difference value between a current dbru value and a previous dbru value of the transmission container;
obtaining a bandwidth calculation result according to at least a current bandwidth allocated to the transmission container and the difference value; and
determining a next bandwidth of the transmission container according to at least the bandwidth calculation result.

4. The DBA method of claim 3, wherein obtaining the bandwidth calculation result according to at least the current bandwidth allocated to the transmission container and the difference value comprises:
calculating an adjustment amount according to the difference value; and
obtaining the bandwidth calculation result according to the current bandwidth and the adjustment amount.

5. The DBA method of claim 4, wherein calculating the adjustment amount according to the difference value comprises:
determining whether a peak and a trough occur in a bandwidth allocation process of the transmission container; and
before the peak and the trough occur in the bandwidth allocation process of the transmission container, multiplying the difference value by a first parameter to generate a first product as the adjustment amount.

6. The DBA method of claim 5, wherein calculating the adjustment amount according to the difference value further comprises:
after the peak and the trough occur in the bandwidth allocation process of the transmission container, multiplying the difference value by a second parameter to generate a second product as the adjustment amount, wherein the second parameter is smaller than the first parameter.

7. The DBA method of claim 6, wherein the difference value is smaller than zero, and multiplying the difference value by the second parameter to generate the second product as the adjustment amount comprises:
determining whether a bandwidth calculation result calculated from the current bandwidth and the first product is smaller than a threshold between the peak and the trough; and
in response to the bandwidth calculation result calculated from the current bandwidth and the first product being smaller than the threshold between the peak and the trough, multiplying the difference value by the second parameter to generate the second product as the adjustment amount.

8. The DBA method of claim 6, wherein the difference value is larger than zero, and multiplying the difference value by the second parameter to generate the second product as the adjustment amount comprises:
determining whether a bandwidth calculation result calculated from the current bandwidth and the first product is larger than a threshold between the peak and the trough; and
in response to the bandwidth calculation result calculated from the current bandwidth and the first product being larger than the threshold between the peak and the trough, multiplying the difference value by the second parameter to generate the second product as the adjustment amount.

9. The DBA method of claim 6, wherein multiplying the difference value by the second parameter to generate the second product as the adjustment amount comprises:
determining whether a difference value between the peak and the trough is larger than a threshold;
in response to the difference value between the peak and the trough being larger than the threshold, using a first value to set the second parameter; and
in response to the difference value between the peak and the trough not being larger than the threshold, using a second value to set the second parameter, wherein the second value is smaller than the first value.

10. The DBA method of claim 4, wherein calculating the adjustment amount according to the difference value comprises:
determining whether the difference value is smaller than a threshold; and
in response to the difference value being smaller than the threshold, directly using the difference value as the adjustment amount.

11. The DBA method of claim 3, wherein obtaining the bandwidth calculation result according to at least the current bandwidth allocated to the transmission container and the difference value comprises:
determining whether the difference value is equal to zero;
determining whether the current dbru value is smaller than a threshold;
in response to the difference value being equal to zero and the current dbru value being smaller than the threshold, multiplying the current bandwidth by a first parameter to generate a first product as the bandwidth calculation result, wherein the first parameter is smaller than 1; and
in response to the difference value being equal to zero and the current dbru value not being smaller than the threshold, multiplying the current bandwidth by a second parameter to generate a second product as the bandwidth calculation result, wherein the second parameter is larger than 1.

12. The DBA method of claim 3, wherein determining the next bandwidth of the transmission container according to at least the bandwidth calculation result comprises:
determining whether there is at least one transmission container with insufficient bandwidth; and
in response to absence of the at least one transmission container with insufficient bandwidth, using the bandwidth calculation result as the next bandwidth of the transmission container.

13. The DBA method of claim 3, wherein determining the next bandwidth of the transmission container according to at least the bandwidth calculation result comprises:
determining whether there is at least one transmission container with insufficient bandwidth;
determining whether the bandwidth calculation result is larger than a relative average bandwidth of the transmission container; and
in response to presence of the at least one transmission container with insufficient bandwidth and the bandwidth calculation result being larger than the relative average bandwidth of the transmission container, using the relative average bandwidth as the next bandwidth of the transmission container instead.

14. The DBA method of claim 3, wherein referring to the plurality of current dbru values corresponding to the plurality of transmission containers, respectively, and the plurality of current valid-data ratios corresponding to the plurality of transmission containers, respectively, to determine the plurality of next bandwidths that are allocated to the plurality of transmission containers, respectively, further comprises:
determining whether the available upstream bandwidth still has remaining bandwidth available for allocation after calculation of the plurality of next bandwidths allocated to the plurality of transmission containers is completed;
determining whether the plurality of transmission containers comprise at least one transmission container with insufficient bandwidth; and
in response to the available upstream bandwidth still having remaining bandwidth available for allocation after calculation of the plurality of next bandwidths allocated to the plurality of transmission containers is completed and the plurality of transmission containers comprising the at least one transmission container with insufficient bandwidth, sharing the remaining bandwidth equally among the at least one transmission container.

15. An optical line terminal (OLT) comprising:
a receiver circuit, wherein within an available upstream bandwidth of the OLT, the receiver circuit is configured to receive an upstream frame that is sent via a plurality of transmission containers with a plurality of current bandwidths allocated thereto in a time division multiple access (TDMA) manner; and
a processor, configured to perform dynamic bandwidth allocation (DBA), wherein the processor is configured to refer to a plurality of current dynamic bandwidth report unit (dbru) values corresponding to the plurality of transmission containers, respectively, and a plurality of current valid-data ratios corresponding to the plurality of respectively, determine a transmission containers, transmission containers, respectively, to determine a plurality of next bandwidths that are allocated to the plurality of transmission containers, respectively.

16. The OLT of claim 15, wherein regarding each transmission container included in the plurality of transmission containers, the processor is configured to:
determine whether a current dbru value of the transmission container is equal to zero;
determine whether a current valid-data ratio of the transmission container is smaller than a threshold; and
allocate a minimum bandwidth to the transmission container as a next bandwidth of the transmission container when the current dbru value of the transmission container is equal to zero and the current valid-data ratio of the transmission container is smaller than the threshold.

17. The OLT of claim 15, wherein regarding each transmission container included in the plurality of transmission containers, the processor is configured to:
calculate a difference value between a current dbru value and a previous dbru value of the transmission container;
obtain a bandwidth calculation result according to at least a current bandwidth allocated to the transmission container and the difference value; and
determine a next bandwidth of the transmission container according to at least the bandwidth calculation result.

18. The OLT of claim 17, wherein the processor is configured to calculate an adjustment amount according to the difference value, and obtain the bandwidth calculation result according to the current bandwidth and the adjustment amount.

19. The OLT of claim 17, wherein the processor is configured to:
determine whether the difference value is equal to zero;
determine whether the current dbru value is smaller than a threshold;
multiply the current bandwidth by a first parameter to generate a first product as the bandwidth calculation result when the difference value is equal to zero and the current dbru value is smaller than the threshold, wherein the first parameter is smaller than 1; and
multiply the current bandwidth by a second parameter to generate a second product as the bandwidth calculation result when the difference value is equal to zero and the current dbru value is not smaller than the threshold, wherein the second parameter is larger than 1.

20. The OLT of claim 17, wherein the processor is configured to:
determine whether the available upstream bandwidth still has remaining bandwidth available for allocation after calculation of the plurality of next bandwidths allocated to the plurality of transmission containers is completed;
determine whether the plurality of transmission containers comprise at least one transmission container with insufficient bandwidth; and
share the remaining bandwidth equally among the at least one transmission container when the available upstream bandwidth still has remaining bandwidth available for allocation after calculation of the plurality of next bandwidths allocated to the plurality of transmission containers is completed and the plurality of transmission containers comprise the at least one transmission container with insufficient bandwidth.
